(19) United States
(12) Patent Application Publication
(10) Pub. No.: US 2009/0309326 A1
(43) Pub. Date: Dec. 17, 2009

(54) HAND AND LEGS DRIVING CYCLE

(76) Inventor: Jin Man Choi, Chungcheongbuk-do (KR)

Correspondence Address: HARNESS, DICKEY & PIERCE, P.L.C., P.O. BOX 828, BLOOMFIELD HILLS, MI, 48303, US

(21) Appl. No.: 11/659,046

(22) PCT Filed: Jun. 30, 2005
(86) PCT No.: PCT/KR2005/002058

§ 371 Date: Sep. 2, 2009

(30) Foreign Application Priority Data
Aug. 2, 2004 (KR) 10-2004-0060750
May 10, 2005 (KR) 10-2005-0039588

(51) Int. Cl. B62M 1/12

(52) U.S. Cl. 280/233

(57) ABSTRACT

A cycle has an automatic steering wheel; a frame, the front portion of which the automatic steering wheel is perpendicularly rotatably connected to; a pair of handle bars, the central portions of which are rotatably hinged to both sides of the upper part of the front portion of the frame; a front crank horizontally passing through the central portion of the frame and rotatably connected to the frame, a crank gear being fixedly connected to said front crank; a rear crank horizontally passing through the rear portion of the frame and rotatably connected to the frame; a pair of connecting rods, each of which has one end rotatably connected to the lower end of the corresponding handle bar and the other end rotatably hinged to the front crank; a pair of pedals, each of which has a front end inserted into the front crank and a rear end inserted into the rear crank so that the pedals are rotatably connected between the front and rear cranks; a rear wheel rotatably connected to the rear portion of the frame and provided with a free gear rotated only in one direction; a chain for interconnecting the crank gear and the free gear of the rear wheel; and a saddle rotatably hinged to the upper part of the rear portion of the frame. The hand and foot driven cycle allows a user to simultaneously use both hands and feet so as to travel forwards, thereby promoting the balanced development of the user's body and increasing speed.

### TECHNICAL FIELD

The present invention relates to a hand and foot driven cycle, and more particularly to a hand and foot driven cycle, which allows a user to move the center of his/her body right and left to change his/her traveling direction so that the user can simultaneously use both hands and feet.

### BACKGROUND ART

In general, apparatuses for generating driving force using the human body includes bicycles and kick boards. Conventional bicycles and kick boards change their traveling directions using user's hands, and generate driving force using user's feet.

The conventional bicycles and kick boards, change their traveling directions using user's hands and generate driving force using user's feet, or change their traveling directions using user's foot and generate driving force using user's hands, thus causing abnormal development of user's body.

### DISCLOSURE OF INVENTION

### Technical Problem

Therefore, the present invention has been made in view of the above problems, and it is an object of the present invention to provide a hand and foot driven cycle, which simultaneously uses user's hands or feet, having been used for changing a traveling direction, in order to move forwards, and allows a user to assume a driving posture similar to user's walking posture, thereby promoting the balanced development of user's body and allowing a user to easily learn to ride it without falling over.

### Technical Solution

In accordance with an aspect of the present invention, the above and other objects can be accomplished by the provision of a hand and foot driven cycle comprising: an automatic steering wheel; a frame, the front portion of which the automatic steering wheel is perpendicularly rotatably connected to, comprising a front wheel fork housing installed at the front end thereof for installing the automatic steering wheel and a rear wheel fork installed at the rear end thereof for installing the rear wheel; a pair of handle bars, the central portions of which are rotatably hinged to both sides of the upper part of the front portion of the frame; a front crank horizontally passing through the central portion of the frame and rotatably connected to the frame, a crank gear being fixedly connected to the front crank; a rear crank horizontally passing through the rear portion of the frame and rotatably connected to the frame; a pair of connecting rods, each of which has one end rotatably connected to the lower end of the corresponding handle bar and the other end rotatably hinged to the front crank; a pair of pedals, each of which has a front end inserted into the front crank and a rear end inserted into the rear crank so that the pedals are rotatably connected between the front and rear cranks; a rear wheel rotatably connected to the rear portion of the frame and provided with a free gear rotated only in one direction; a chain for interconnecting the crank gear and the free gear of the rear wheel; and a saddle rotatably hinged to the upper part of the rear portion of the frame, wherein a user holds handles attached to the handle bars with both hands, places one foot on one pedal, kicks the ground with the other foot and places the other foot on the other pedal, alternately moves both hands back and forth and simultaneously alternately presses both pedals so as to travel forwards, and the user steps on the ground using one foot and generates friction between the foot and the ground so as to stop the traveling.

Preferably, the fork may have a saw-toothed shape so that a distance between a point of the wheel, contacting the fork, and a steering shaft is varied.

The hand and foot driven cycle may further comprise a steering apparatus comprising: a knuckle arm transversely slantingly formed at a shoulder portion of a front wheel fork, and having a hinge hole formed through one end thereof; a tie rod, one end of which is hinged to the end of the knuckle arm through the hinge hole; and a steering bar having a hinge hole formed through an end of a Y-shaped branch thereof so that the other end of the tie rod is hinged to the hinge hole, and a hinge hole formed through the central portion thereof so that a steering bar fixing rod integrally formed with the lower end of the front portion of the frame such that the steering bar fixing rod is perpendicular to the frame is hinged to the hinge hole, and both ends having the same structure as both ends of the handle bar fixing rods so that the connecting rods are easily detachably attached to both ends of the steering bar.

### Advantageous Effects

The hand and foot driven cycle of the present invention simultaneously uses user's hands and feet to generate forwards traveling force, thereby efficiently moving and allowing a user to exercise in a posture similar to a walking posture to promote the balanced development of user's body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a hand and foot driven cycle in accordance with a first embodiment of the present invention;

FIG. 2 is a side view of the hand and foot driven cycle in accordance with the first embodiment of the present invention in an operating state;

FIG. 3 is a perspective view of a frame of the hand and foot driven cycle in accordance with the first embodiment of the present invention;

FIG. 4 is a perspective view of a handle bar of the hand and foot driven cycle in accordance with the first embodiment of the present invention;

FIG. 5 is a front view of a crank of the hand and foot driven cycle in accordance with the first embodiment of the present invention;

FIG. 6 is a perspective view of a connecting rod of the hand and foot driven cycle in accordance with the first embodiment of the present invention;

FIG. 7 is a perspective view of a pedal of the hand and foot driven cycle in accordance with the first embodiment of the present invention;

FIG. 8 is a perspective view of a saddle of the hand and foot driven cycle in accordance with the first embodiment of the present invention;

FIG. 9 is a side view of the hand and foot driven cycle in accordance with the first embodiment of the present invention in a state in which the handle bars are fixed;

FIG. 10 is a side view of the hand and foot driven cycle in accordance with the first embodiment of the present invention in a folded state;

FIG. 11 is a top view of a steering gear of a hand and foot driven cycle in accordance with a second embodiment of the present invention; and

FIG. 12 is a side view of the hand and foot driven cycle in accordance with the second embodiment of the present invention in a state in which the hand and foot driven cycle is converted into a general bicycle.

### BEST MODE FOR CARRYING OUT THE INVENTION

Now, preferred embodiments of the present invention will be described in detail with reference to the annexed drawings.

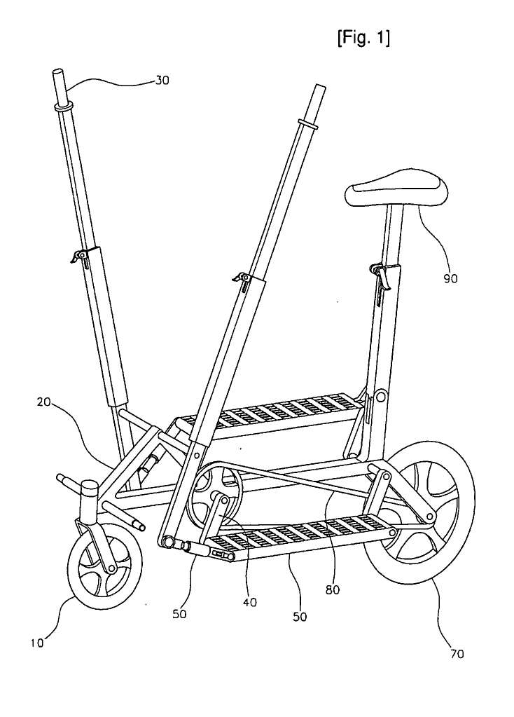

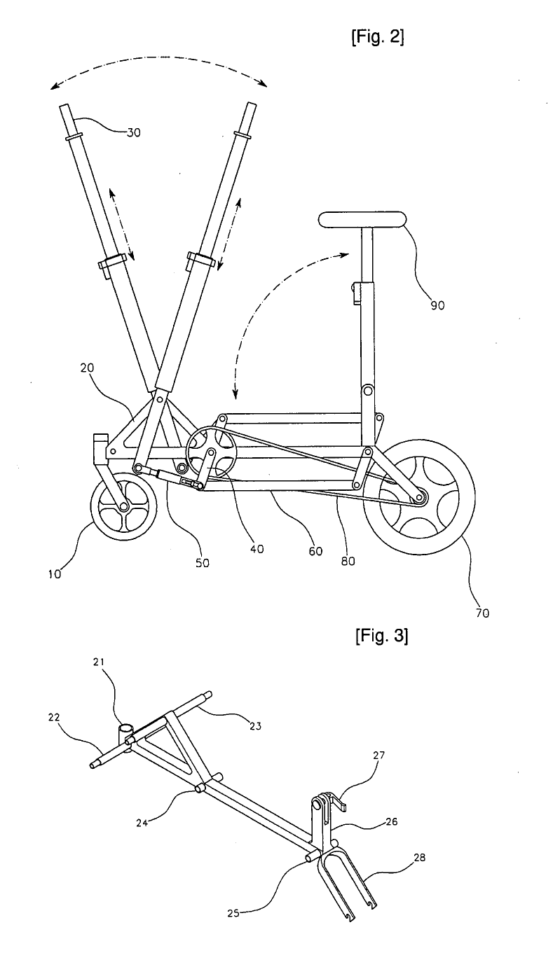

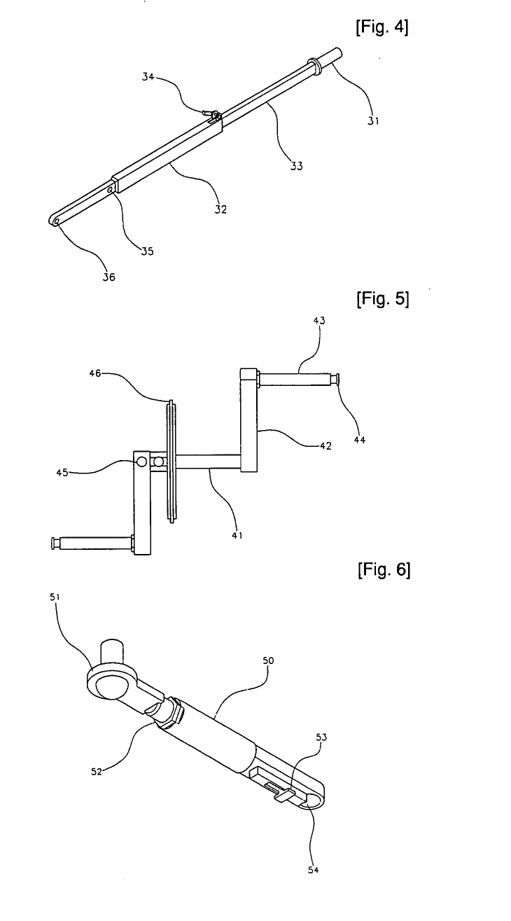

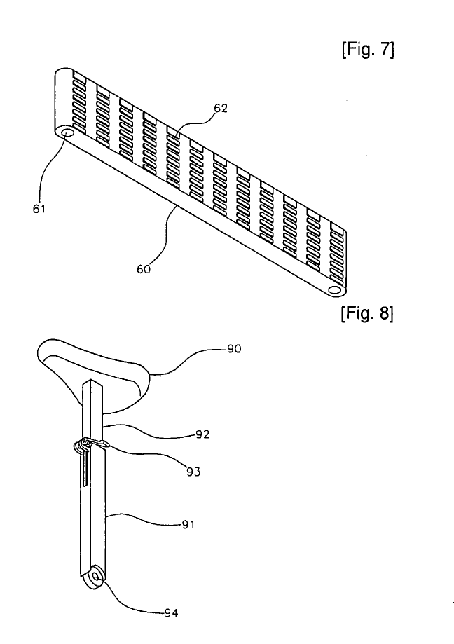

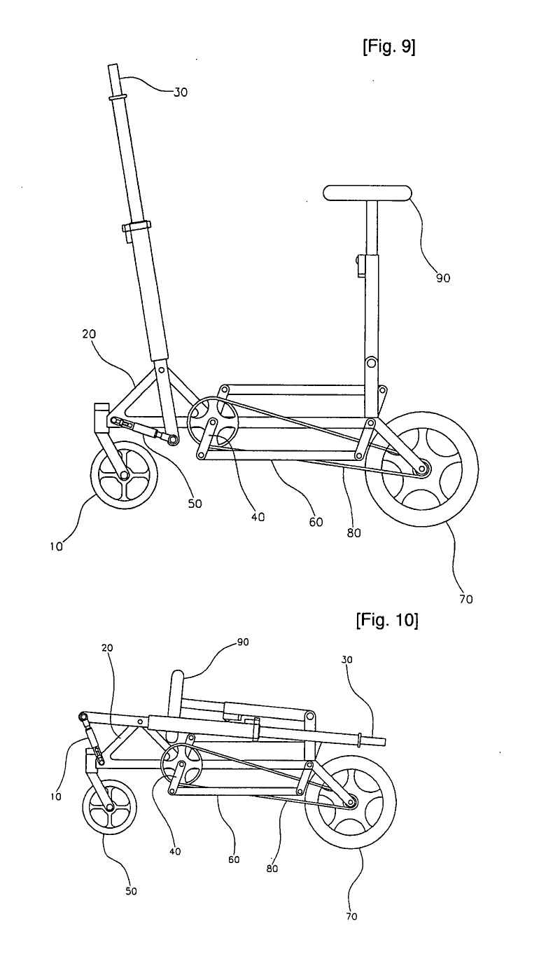

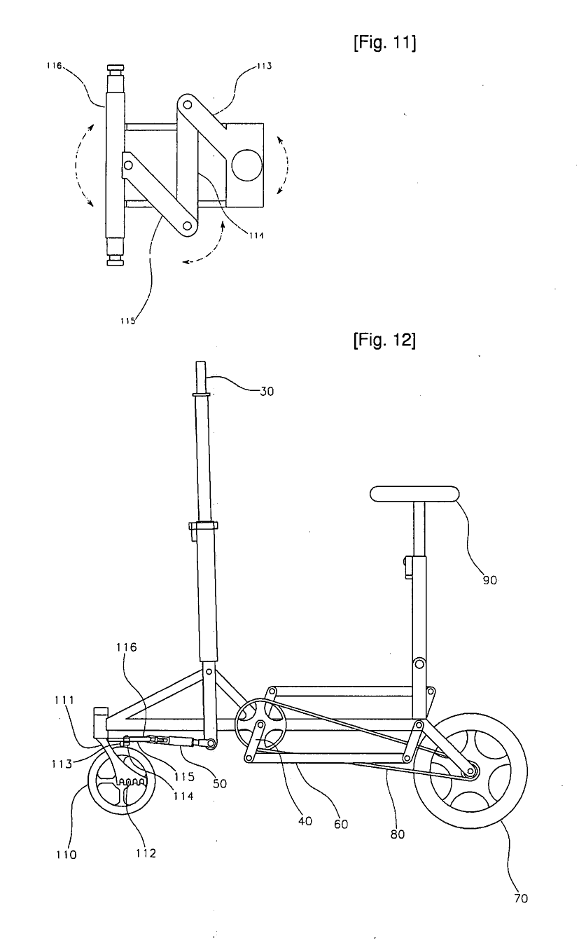

FIG. 1 is a perspective view of a hand and foot driven cycle in accordance with a first embodiment of the present invention. FIG. 2 is a side view of the hand and foot driven cycle in accordance with the first embodiment of the present invention in an operating state. FIG. 3 is a perspective view of a frame of the hand and foot driven cycle in accordance with the first embodiment of the present invention. FIG. 4 is a perspective view of a handle bar of the hand and foot driven cycle in accordance with the first embodiment of the present invention. FIG. 5 is a front view of a crank of the hand and foot driven cycle in accordance with the first embodiment of the present invention. FIG. 6 is a perspective view of a connecting rod of the hand and foot driven cycle in accordance with the first embodiment of the present invention. FIG. 7 is a perspective view of a pedal of the hand and foot driven cycle in accordance with the first embodiment of the present invention. FIG. 8 is a perspective view of a saddle of the hand and foot driven cycle in accordance with the first embodiment of the present invention. FIG. 9 is a side view of the hand and foot driven cycle in accordance with the first embodiment of the present invention in a state in which the handle bars are fixed. FIG. 10 is a side view of the hand and foot driven cycle in accordance with the first embodiment of the present invention in a folded state. FIG. 11 is a top view of a steering gear of a hand and foot driven cycle in accordance with a second embodiment of the present invention. FIG. 12 is a side view of the hand and foot driven cycle in accordance with the second embodiment of the present invention in a state in which the hand and foot driven cycle is converted into a general bicycle.

As shown in FIG. 2, a hand and foot driven cycle in accordance with the first embodiment of the present invention comprises an automatic steering wheel 10, a frame 20, a pair of handle bars 30, front and rear cranks 40, a pair of connecting rods 50, a pair of pedals, a rear wheel 70, a chain 80, and a saddle 90.

The automatic steering wheel 10 employs one selected from conventional single wheel and a pair of wheels, which are configured such that a fork manufactured by a precasting method is inclined backwards and a point of a tire, contacting the fork, is located in the rear of a steering shaft, and wheels filed by the present applicant (disclosed by a second embodiment of Korean Patent Application No. 10-2003-0076541 and disclosed by Korean Patent Application No. 10-2004-0092220), and the detailed description of the structure and operation of the automatic steering wheel 10 will thus be omitted. The automatic steering wheel 10 is rotatably connected to a front wheel fork housing 21 of the frame 20.

As shown in FIG. 3, the frame 20 comprises the front wheel fork housing 21 installed at the front end thereof for installing the automatic steering wheel 10, a rear wheel fork 28 installed at the rear end thereof for installing the rear wheel 70, a pair of handle bar fixing rods 22 protruded from the front portion thereof, a pair of handle bar connecting rods 23 located in the rear of the handle bar fixing rods 22, a front crank housing 24 formed at the central portion thereof, a rear crank housing 25 formed at the rear portion thereof, and a saddle receiving rod 26 including a saddle support bar adjusting lever 27 having an eccentric cam installed on the upper part of the rear portion thereof. Here, the handle bar fixing rods 22, the handle bar connecting rods 23, the front crank housing 24, the rear crank housing 25, and the saddle receiving rod 26 are formed integrally with the frame 20 such that they are perpendicular to the frame 20.

The handle bars 30 are a pair of rod members. As shown in FIG. 4, each of the handle bars 30 comprises a first handle bar 32, a second handle bar 33, one end of which is inserted into one end of the first handle bar 32, a handle bar adjusting lever 34 having an eccentric cam for adjusting the length of the handle bar 31, a handle 31 attached to the upper end thereof, a handle bar fixing hole 35 formed through the central portion of the first handle bar 32, and a connecting rod fixing hole 36 formed through the lower end of the first handle bar 32. The handle bars 30 are rotatably hinged to the handle bar connecting rods 23 of the frame 20 and fixed to the handle bar connecting rods 23 by nuts so that a user holds the handles 31 with both hands and alternately moves the handle bars 30 to drive the hand and foot driven cycle.

As shown in FIG. 5, each of the front and rear cranks 40 is configured such that a crank gear 46 is fixed to one end of a crank shaft 41 by a bolt and is rotatably connected to the front and rear crank housings 24 and 25, ends of a pair of crank arms 42 are fixed to both ends of the crank shaft 41 by bolts 45, and ends of a pair of pedal shafts 43 are fixedly connected to the other ends of a pair of the crank arms 42.

As shown in FIG. 6, a bolt portion of a ball joint 51 is inserted into one end of the connecting rod 50, and is fixed to the connecting rod 50 using a ball joint fixing nut 52 so that the end of the connecting rod 59 is connected to the connecting rod fixing hole 36 formed through the lower end of the first handle bar 30, and a detachable hand grip 53 of a key 54, which is elastically supported by a spring, moves back and forth to detachably attach the other end of the connecting rod 50 to the pedal 60 or the pedal shaft 43. When the hand and foot driven cycle is driven simultaneously by user's hands and feet, the connecting rods 50 are connected to the pedals 60 or the pedal shafts 43, and when the handle bars 30 are fixed so that the hand and foot driven cycle is driven only by user's feet, the connecting rods 50 are connected to the handle bar fixing rods 22 of the frame 20.

The pedals 60 are made of a pair of plate members. Further, as shown in FIG. 7, the pedal shafts 43 of the front and rear cranks 40 are rotatably inserted into pedal shaft insertion holes 61 formed through both side ends of the pedals 60. Preferably, skid-proof protrusions 62 are formed on the upper surface of the pedals 60. The user alternately vertically moves both feet under the condition that his/her feet are respectively placed upon the pedals 60, thereby allowing the hand and foot driven cycle to travel forwards.

The rear wheel 70 is a wheel having a free gear attached thereto, which is rotatable only in one direction, and is rotatably connected to the rear wheel fork 28 of the frame 20. Since a conventional known wheel is used as the rear wheel 70, the description of the structure and operation of the rear wheel 70 will be omitted.

Since a conventional known chain is used as the chain 80, the description of the structure and operation of the chain 80 will be omitted.

As shown in FIG. 8, the saddle 90 is made of a rod material, and is configured such that one end of a second saddle support bar 92 is inserted into one end of a first saddle support bar 91 so that the length of the saddle 90 is adjusted using a saddle adjusting lever 93 having an eccentric cam, a saddle cushion is attached to the upper end of the second saddle support bar 92, a saddle support bar fixing hole 94 is formed through the lower end of the first saddle support bar 91 so that the saddle 90 is rotatably hinged to the lower end of the saddle receiving rod 26 of the frame 20, and the angle between the first and second saddle support bars 91 and 92 is adjusted using the saddle support bar adjusting lever 27 having an eccentric cam.

The hand and foot driven cycle of the present invention further comprises a known brake gear and a known parking brake gear. That is, brake levers are respectively attached to the handles 31 of the handle bars 30, brakes are respectively installed at the wheels 10 and 70, and the brake levers and the brakes are connected by cables. Thus, the description of the structure, the installation method, and the operation of the brake gear and the parking brake gear will be omitted.

The hand and foot driven cycle of the present invention further comprises known speed change gears, which are respectively installed at the crank gear 46 and the rear wheel 70. Thus, the description of the structure, the installation method, and the operation of the speed change gears will be omitted.

### MODE FOR THE INVENTION

As shown in FIG. 11, a hand and foot driven cycle in accordance with the second embodiment of the present invention employs a front wheel fork 111 and a steering apparatus. That is, the steering apparatus comprises a knuckle arm 113, a tie rod 114, and a steering bar 115.

The fork 111 has a saw-toothed shape having a plurality of grooves 112 for fixing a front wheel 110, and can be connected to the front wheel 110 under the condition that a distance between a point of the front wheel 110, contacting the fork 111, and a steering shaft is varied. When the distance between the contact point of the front wheel 110 and the steering shaft is short, the restoring force of the frame is increased so that the hand and foot driven cycle of the present invention is advantageous to a beginner, and when the distance between the contact point of the front wheel 110 and the steering shaft is long, the stability of the hand and foot driven cycle at a high speed is increased so that the hand and foot driven cycle of the present invention is advantageous to an expert.

The knuckle arm 113 is transversely slantingly formed at a shoulder portion of the fork 111, and one end of the tie rod 114 is hinged to the knuckle arm 113 through a hinge hole formed through one end of the knuckle arm 113.

Hinge rods having a snap ring groove are respectively orthogonally inserted into both ends of the tie rod 114. Thereby, both ends of the tie rod 114 are hinged to the steering bar 115 and the knuckle arm 113, and fixed to the steering bar 115 and the knuckle arm 113 using snap rings.

The steering bar 115 includes a hinge hole respectively formed through one end of a Y-shaped branch thereof and a hinge hole formed through the central portion thereof, and is hinged to a steering bar fixing rod 116 integrally perpendicular to the lower end of the front portion of the frame 20. Both ends of the steering bar 115 have the same structure as both ends of the handle bar fixing rods 22 so that the connecting rods 50 are easily detachably attached to both ends of the steering bar 115.

The above-structured steering apparatus is configured such that ends of the connecting rods 50 separated from the pedals 60 are attached to both ends of the steering bars 115. Hereinafter, the operation of the steering apparatus will be described as follows.

When a user pulls the right handle 31, the right connecting rod 50 moves forwards and the steering bar 115 is rotated to the left so that the tie rod 114 pushes the knuckle arm 113. Then, the front wheel 110 is rotated to the right. Thereby, the hand and foot driven cycle of the present invention is operated in the same manner as a conventional cycle in which a front wheel is steered using handles.

### INDUSTRIAL APPLICABILITY

As apparent from the above description, the present invention provides a hand and foot driven cycle, which is employed in conventional sporting goods, bicycles, and kick boards, thereby preventing human body from being partially abnormally developed and being interchangeably used as a sports system and a transportation system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A hand and foot driven cycle comprising:
an automatic steering wheel;
a frame, the front portion of which the automatic steering wheel is perpendicularly rotatably connected to;
a pair of handle bars, the central portions of which are rotatably hinged to both sides of the upper part of the front portion of the frame;
a front crank horizontally passing through the central portion of the frame and rotatably connected to the frame, a crank gear being fixedly connected to said front crank;
a rear crank horizontally passing through the rear portion of the frame and rotatably connected to the frame;
a pair of connecting rods, each of which has one end rotatably connected to the lower end of the corresponding handle bar and the other end rotatably hinged to the front crank;
a pair of pedals, each of which has a front end inserted into the front crank and a rear end inserted into the rear crank so that the pedals are rotatably connected between the front and rear cranks;
a rear wheel rotatably connected to the rear portion of the frame and provided with a free gear rotated only in one direction;
a chain for interconnecting the crank gear and the free gear of the rear wheel; and
a saddle rotatably hinged to the upper part of the rear portion of the frame, wherein a user holds handles attached to the handle bars with both hands, places one foot on one pedal, kicks the ground with the other foot and places the other foot on the other pedal, alternately moves both hands back and forth and simultaneously alternately presses both pedals so as to travel forwards, and the user steps on the ground using one foot and generates friction between the foot and the ground so as to stop the traveling.

2. The hand and foot driven cycle as set forth in claim 1, wherein a fork for holding the automatic steering wheel has a saw-toothed shape so that a distance between a point of the wheel, contacting the fork, and a steering shaft is varied, and when the distance between the contact point of the wheel and the steering shaft is short, the restoring force of the frame is increased so that the hand and foot driven cycle is advantageous to a beginner, and when the distance between the contact point of the wheel and the steering shaft is long, the stability of the hand and foot driven cycle at a high speed is increased so that the hand and foot driven cycle is advantageous to an expert.

3. The hand and foot driven cycle as set forth in claim 1, further comprising a brake gear for braking the hand and foot driven cycle, having brake levers attached to the handles of the handle bars and brakes installed at the wheels, said brake levers and said brakes being interconnected by cables.

4. The hand and foot driven cycle as set forth in claim 1, further comprising speed change gears respectively installed at the crank gear and the rear wheel.

5. The hand and foot driven cycle as set forth in claim 1, wherein the frame comprises:
a front wheel fork housing installed at the front end thereof for installing the automatic steering wheel;
a rear wheel fork installed at the rear end thereof for installing the rear wheel;
a pair of handle bar fixing rods protruded from the front portion thereof such that the handle bar fixing rods are formed integrally with and perpendicularly to the frame;
a pair of handle bar connecting rods located in the rear of the handle bar fixing rods such that the handle bar connecting rods are formed integrally with and perpendicularly to the frame;
a front crank housing formed at the central portion thereof such that the front crank housing is formed integrally with and perpendicularly to the frame;
a rear crank housing formed at the rear portion thereof such that the rear crank housing is formed integrally with and perpendicularly to the frame; and
a saddle receiving rod including a saddle support bar adjusting lever having an eccentric cam installed on the upper portion of the rear portion thereof such that the saddle receiving rod is formed integrally with the frame.

6. The hand and foot driven cycle as set forth in claim 1, wherein each of the handle bars comprises:
a first handle bar;
a second handle bar, one end of which is inserted into one end of the first handle bar;
a handle bar adjusting lever having an eccentric cam for adjusting the length of the handle bar;
a handle attached to the upper end of the second handle bar;
a handle bar fixing hole formed through the central portion of the first handle bar;
a connecting rod fixing hole formed through the lower end of the first handle bar, wherein the handle bars are rotatably hinged to the corresponding handle bar fixing rods of the frame and fixed to the handle bar fixing rods by nuts so that a user holds the handles with both hands and alternately moves the handle to drive the hand and foot driven cycle.

7. The hand and foot driven cycle as set forth in claim 1, wherein the front crank is configured, such that the crank gear is fixed to one end of a crank shaft by a bolt, and is rotatably connected to the front crank housing of the frame, ends of a pair of crank arms are fixed to both ends of the crank shaft by bolts, and ends of a pair of pedal shafts are fixedly connected to the other ends of a pair of the crank arms.

8. The hand and foot driven cycle as set forth in claim 1, wherein a bolt portion of a ball joint is inserted into one end of each of a pair of the connecting rods, and is fixed to the connecting rod using a ball joint fixing nut so that the end of the connecting rod is connected to the connecting rod fixing hole formed through the lower end of the first handle bar, and a detachable hand grip of a key, which is elastically supported by a spring, moves back and forth to detachably attach the other end of the connecting rod to corresponding one of pedal shafts; and when the hand and foot driven cycle is driven simultaneously by user's hands and feet, the connecting rods are connected to the pedal shafts, and when the handle bars are fixed so that the hand and foot driven cycle is driven only by user's feet, the connecting rods are connected to the handle bar fixing rods of the frame.

9. The hand and foot driven cycle as set forth in claim 1, wherein pedal shafts of the front and rear cranks are rotatably inserted into pedal shaft insertion holes formed through both side ends of the pedals, the separation of the pedal shafts of the front crank from the pedals is prevented by inserting keys of the connecting rods from the outside into key holes formed through pedal shafts and the separation of the pedal shafts of the rear crank from the pedals is prevented using snap rings, skid-proof protrusions are formed on the upper surface of the pedals, and a user vertically alternately moves both feet under the condition that the feet are placed on the pedals so as to allow the hand and foot driven cycle to travel forwards.

10. The hand and foot driven cycle as set forth in claim 1, wherein the saddle is configured such that one end of a second saddle support bar is inserted into one end of a first saddle support bar so that the length of the saddle is adjusted using a saddle adjusting lever having an eccentric cam, a saddle cushion is attached to the upper end of the second saddle support bar, a saddle support bar fixing hole is formed through the lower end of the first saddle support bar so that the saddle is rotatably hinged to the lower end of a saddle receiving rod of the frame, and the angle between the first and second saddle support bars is adjusted using a saddle support bar adjusting lever having an eccentric cam.

11. The hand and foot driven cycle as set forth in claim 2, further comprising a steering apparatus comprising:
a knuckle arm transversely slantingly formed at a shoulder portion of a front wheel fork, and having a hinge hole formed through one end thereof;
a tie rod, one end of which is hinged to the end of the knuckle arm through the hinge hole; and
a steering bar having a hinge hole formed through an end of a Y-shaped branch thereof so that the other end of the tie rod is hinged to the hinge hole, and a hinge hole formed through the central portion thereof so that a steering bar fixing rod integrally formed with the lower end of the front portion of the frame such that the steering bar fixing rod is perpendicular to the frame is hinged to the hinge hole, and both ends having the same structure as both ends of the handle bar fixing rods so that the connecting rods are easily detachably attached to both ends of the steering bar.
